(19) United States
(12) Patent Application Publication
(10) Pub. No.: US 2020/0156496 A1
(43) Pub. Date: May 21, 2020

(54) METHOD AND SYSTEM FOR POWER MANAGEMENT OF A FLEET OF ELECTRIC VEHICLES

(71) Applicant: Cummins Inc., Columbus, IN (US)

(72) Inventor: Jennifer Kay Light-Holets, Greenwood, IN (US)

(21) Appl. No.: 16/688,672

(22) Filed: Nov. 19, 2019

Related U.S. Application Data
(60) Provisional application No. 62/769,846, filed on Nov. 20, 2018.

(51) Int. Cl. B60L 53/64; B60L 58/12; B60L 53/10; B60L 53/63; B60L 53/62; G01C 21/34

(52) U.S. Cl. CPC B60L 53/64; B60L 58/12; G01C 21/3469; B60L 53/63; B60L 53/62; B60L 53/10

(57) ABSTRACT

A method and system are provided for managing power in a plurality of electric vehicles. The method and system determine a current state of charge of a battery and a predicted power demand for each vehicle, and then charge batteries of the vehicles during a first period of time when the vehicles are not in use.

### CROSS-REFERENCE TO RELATED APPLICATIONS

The present application claims the benefit of U.S. Provisional Application No. 62/769,846, filed Nov. 20, 2018, the subject matter of which is expressly incorporated herein by reference.

### FIELD OF THE DISCLOSURE

The present disclosure relates generally to electric vehicles, especially to managing power of a group of electric vehicles with specialized driving schedules, such as school buses.

### BACKGROUND OF THE DISCLOSURE

School buses are a unique form of transit buses with respect to their schedule. For instance, in a suburban school district, a typical school bus may be run from 6:30 AM to 9:30 AM each morning (which consists of two runs of the route; one for the older children and the other for the younger children, whose commuting times are scheduled as to avoid any overlap) and again from 2:00 PM to 5:00 PM (again, two runs to deliver the different age children home). A small subset of buses may be used during the timeframe from 9:30 AM to 2:00 PM for field trips and/or after 5:00 PM for afterschool/athletic events. However, the vast majority of the school buses are only used during two blocks of time. FIG. 1 illustrates these two blocks of time that are used for transit during a typical school day.

Recently, there has been an upsurge in the number of electric vehicles as awareness for more ecofriendly transportation methods increases among the general population. As compared to school buses that typically run on diesel fuel, electric-run school buses have the potential to drastically reduce the amount of pollutants being released into the atmosphere. Also, replacing diesel-powered school buses with electric-powered ones can also reduce the amount of exhaust gas that are inhaled by students riding the school buses, therefore potentially reducing the risk of students experiencing respiratory problems which may be caused by the exhaust gas. However, electric-powered school buses have problems in that it takes time to fully charge their batteries. Therefore, there is a need to use electric-powered school buses to replace the typical diesel-powered counterparts. There is also a need to better utilize the gap in time between the morning runs and the afternoon runs for a typical school bus, when it is not being used at all, to increase the efficiency of the electric-powered school bus from a power-management perspective, especially considering the amount of time it takes for the battery to be fully charged.

### SUMMARY OF THE DISCLOSURE

Various embodiments of the present disclosure relate to methods and devices to manage power for a plurality of electric vehicles, where the methods and devices involve determining a current state of charge of a battery and a predicted power demand for each vehicle, and charging batteries of the plurality of vehicles during a first period of time when the vehicles are not in use. In one example, each of the vehicles makes a first trip and a second trip each day as defined by usage information of the vehicle, and the predicted power demand is calculated based on a distance or time traveled by the vehicle during at least one of the first and second trips.

In another example, a modular power source is attached to at least one of the vehicles when the current state of charge is less than the predicted power demand of the at least one of the vehicles. In yet another example, it is determined whether at least one of the vehicles needs additional power when the current state of charge is less than the predicted power demand of at least one of the vehicles. Then, it is determined whether there is excess power in at least one of the other vehicles when the current state of charge is greater than the predicted power demand of the at least one of the other vehicles. Furthermore, the excess power is supplied to the at least one of the vehicles from the at least one of the other vehicles.

In another embodiment, the methods and devices may determine that there is excess power in at least one of the vehicles when the current state of charge is greater than the predicted power demand of the at least one of the vehicles, after which the excess power is supplied to a power grid during a second period of time when a price of electricity is higher than during the first period of time. Alternately, the excess power is supplied to a power grid during a second period of time when a price of electricity is higher than during the first period of time.

In another embodiment, during a second period of time, power charged during the first period of time is supplied to a power grid, such that a price of electricity is higher during the second period of time than during the first period of time. In one example, which battery of one or more of the vehicles to charge is determined based on the current state of charge and the predicted power demand for the each of the vehicles. The battery of the one or more of the vehicles is charged when the current state of charge is less than the predicted power demand of the one or more of the vehicles.

In another embodiment, the each of the vehicles makes a first trip and a second trip each day as defined by usage information of the vehicle. A first predicted power demand is calculated based on a first distance traveled by the vehicle during the first trip. A second predicted power demand is calculated based on a second distance traveled by the vehicle during the second trip. Then, if the current state of charge is greater than the first predicted power demand and less than a sum of the first and second predicted power demands, the battery of the vehicle is charged during a second period of time after the first trip is completed and before the second trip begins.

In one embodiment, an electric vehicle includes sensors, a battery, and a controller coupled to the sensors and the battery. The sensors detect a current state of charge of the battery and a predicted power demand of the vehicle. The battery is charged during a first period of time when the vehicle is not in use. The controller determines that there is excess power in the battery of the vehicle when the current state of charge is greater than the predicted power demand, and supplies the excess power to a power grid during a second period of time when a price of electricity is higher than during the first period of time. In one example, the controller supplies power charged during the first period of time to a power grid during a second period of time, and a price of electricity is higher during the second period of time than during the first period of time.

In addition, the electric vehicle may include a memory unit which stores usage information of the vehicle. A first predicted power demand is calculated based on a first distance traveled by the vehicle during a first trip as defined by the usage information, and a second predicted power demand is calculated based on a second distance traveled by the vehicle during a second trip as defined by the usage information. Furthermore, if the current state of charge is greater than the first predicted power demand and less than a sum of the first and second predicted power demands, the controller charges the battery of the vehicle during a second period of time after the first trip is completed and before the second trip begins. In one aspect of the embodiment, the controller sends a notification to a user to attach a modular power source to the vehicle when the controller determines that the current state of charge would be depleted before at least one of the first and second trips is completed. Alternatively, the usage information defines at least one additional trip, and the controller sends a notification to a user to attach a modular power source to the vehicle when the controller determines that the current state of charge would be depleted before the at least one additional trip is completed.

In one embodiment, a system for power management includes a plurality of electric vehicles, a power grid, and a central management unit. Each of the vehicles includes a battery, and the central management unit is coupled to the vehicles and the power grid such that the central management unit determines a current state of charge and a predicted power demand for each of the vehicles and charge the batteries during a first period of time when the vehicles are not in use. In one aspect of the embodiment, each of the vehicles further includes a memory unit which stores usage information which defines a first trip and a second trip traveled each day by the vehicle, and the central management unit calculates the predicted power demand based on a distance traveled by the vehicle during at least one of the first and second trips.

Furthermore, the central management unit sends a notification to attach a modular power source to at least one of the vehicles when the central management unit determines that the current state of charge would be depleted before at least one of the first and second trips is completed. Alternately, the usage information defines at least one additional trip, and the central management unit sends a notification to attach a modular power source to at least one of the vehicles when the central management unit determines that the current state of charge would be depleted before the at least one additional trip is completed.

In one example, the central management unit determines that there is excess power in at least one of the vehicles when the current state of charge is greater than the predicted power demand of the at least one of the vehicles. The centralized management unit also supplies the excess power to at least one of: a power grid during a second period of time when a price of electricity is higher than during the first period of time and at least one of the other vehicles. In another example, during a second period of time, power charged during the first period of time is supplied to a power grid, such that a price of electricity is higher during the second period of time than during the first period of time. In yet another example, the central management unit determines which battery of one or more of the vehicles to charge based on the current state of charge and the predicted power demand for the each of the vehicles. The battery of the one or more of the vehicles is charged when the current state of charge is less than the predicted power demand of the one or more of the vehicles.

In one embodiment, each of the vehicles includes a memory unit which stores usage information of the vehicle which defines a first trip and a second trip traveled each day by the vehicle. The central management unit calculates a first predicted power demand based on a first distance traveled by the vehicle during the first trip. The central management unit also calculates a second predicted power demand based on a second distance traveled by the vehicle during the second trip. If the current state of charge is greater than the first predicted power demand and less than a sum of the first and second predicted power demands, the central management unit charges the battery of the vehicle during a second period of time after the first trip is completed and before the second trip begins.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

The embodiments will be more readily understood in view of the following description when accompanied by the below figures and wherein like reference numerals represent like elements. These depicted embodiments are to be understood as illustrative of the disclosure and not as limiting in any way.

FIG. 1 is a chart illustrating the daily schedule of a typical transit school bus on a typical school day;

FIG. 2 is a comparison graph showing the typical real-time hourly price of electricity according to season, where the energy prices are compared between a summer day and a fall, winter, or spring day;

FIG. 3 is a flow chart illustrating the logic used in a computer program which manages power in each of the school bus;

FIG. 4 is a flow chart illustrating another logic used in a computer program which manages power in each of the school bus, where additional trips are placed into consideration;

FIG. 5 is a flow chart illustrating a logic used in a computer program which manages power in each of the school bus, based on whether or not the vehicles are used during the summer vacation;

FIG. 6 is a schematic diagram of an electric school bus whose charge and discharge is controlled by a controller as disclosed herein;

FIG. 7 is a schematic diagram of an electric school bus as disclosed herein, whose battery is coupled to a plurality of detachable modular batteries;

FIG. 8 is a schematic diagram of a system of a fleet of electric school buses coupled to each other as well a power grid, in which the charges and discharges of the school buses are controlled by a centralized management and charge control system as disclosed herein.

While the present disclosure is amenable to various modifications and alternative forms, specific embodiments have been shown by way of example in the drawings and are described in detail below. The intention, however, is not to limit the present disclosure to the particular embodiments described. On the contrary, the present disclosure is intended to cover all modifications, equivalents, and alternatives falling within the scope of the present disclosure as defined by the appended claims.

### DETAILED DESCRIPTION OF THE DISCLOSURE

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments. Furthermore, the described features, structures, or characteristics of the subject matter described herein may be combined in any suitable manner in one or more embodiments.

FIG. 2 illustrates an example of a graph comparing the prices of electricity during a typical day in summer and during a typical day in other seasons. According to the graph, the energy price for a typical day in fall, winter, or spring is the lowest at around 4:00 AM, while the time of the day when the energy price is the highest varies according to the season. During fall, winter, and spring, the two peaks in the energy price occur around 8:00 AM and 8:00 PM, but the energy price falls and reaches a temporary low-point at around 2:00 PM before rising again. In comparison, the energy price fluctuation on a typical summer day is much different. During the summer, the energy price is at its highest at 4:00 PM, with the energy price gradually rising starting at 4:00 AM, and then gradually decreasing back to the lowest price at 4:00 AM. The time periods during which the lowest and highest energy price take place play an important role in managing power for electric products, especially those such as electric vehicles which require many hours to fully charge their batteries.

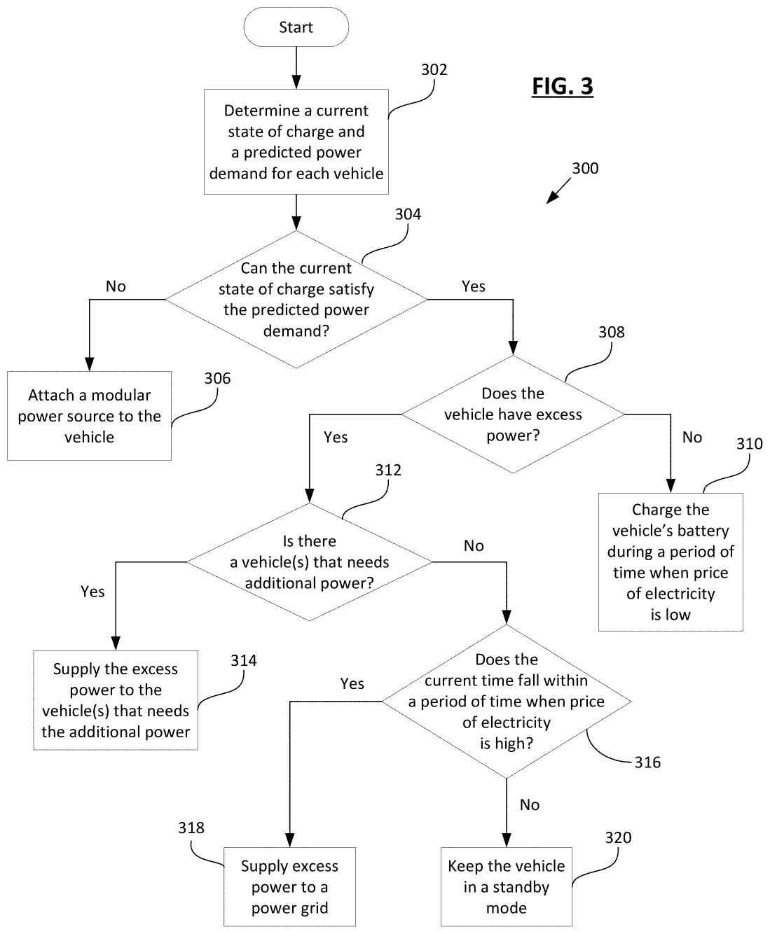

FIG. 3 shows a flow chart representing a method 300 used in the management system of at least one electric vehicle in a fleet of electric vehicles according to one embodiment disclosed herein. The initial step 302 in the method involves determining, by a component within the management system such as a controller or a processing unit, a current state of charge and a predicted power demand for each vehicle. The current state of charge is measured using an ampere-hour meter, for example, which can be used to compare with the predicted power demand. In one example, the predicted power demand is calculated from a predetermined set of routes which the vehicle is scheduled to take during the day, such as the path taken by a school bus to pick up students in the morning and another path taken by the same school bus to drop off the students in the afternoon or early evening, both of which are performed on a typical school day. In one aspect of this example, the routes are determined by GPS-assisted vehicle navigation software such as GPS mapping applications installed on the user's smartphone.

In another example, the predicted power demand is calculated using the distance to be traveled based on the relative distance between the starting point and the destination, which can be determined using a GPS mapping application. In yet another example, the predicted power demand is calculated using the total time in which the user will be driving the vehicle, such as the length of the shift for each driver or an average predicted travel time calculated from the actual travel times of the same route collected over a period of time. Furthermore, in one aspect of the example, the total time can be roughly estimated using the GPS-assisted vehicle navigation software which predicts the traffic load in each route.

In step 304, after comparing the state of charge with the predicted power demand, the management system determines whether the current state of charge will be able to satisfy the predicted power demand, i.e. if the vehicle will be able to make all the trips as planned without completely discharging the battery of the vehicle during the process. Such comparison takes into account possible external factors which may play a role in the total time and/or distance traveled by the vehicle, such as extra time allotted in case of heavy traffic and extra distance traveled in case of a situation where the vehicle needs to take a detour due to unforeseen events including but not limited to constructions and traffic accidents. If the management system determines that the current state of charge is not sufficient, the process proceeds to step 306 in which a modular power source needs to be attached to the vehicle. The modular power source provides at least enough power for the vehicle to finish all the trips planned for the day. In another example, instead of attaching the modular power source, the process may instead charge the vehicle's battery when it is determined that there is enough time to sufficiently charge the battery before the next trip begins.

On the other hand, if the management system determines that the current state of charge is enough to satisfy the predicted power demand, the system then proceeds to step 308 in which it determines whether or not the vehicle has excess power. In one example, excess power is defined by a predetermined value of power in excess of the value necessary to finish all the trips planned for the day, such as having power sufficient for two days' worth of predicted power demand or more. In such case, if the state of charge has less than the predetermined value in excess (for example, only having enough charge to meet a day and a half's predicted power demand or less when the predetermined value corresponds to having enough charge to meet two days' predicted demand) but more than the charge required by the predicted power demand for the day, then the system proceeds to step 310 and the vehicle's battery is charged during a period of time when the price of electricity is low, such as between 12 AM and 6 AM as shown in FIG. 2.

If the system determines that the vehicle has excess power, the system proceeds to step 312 and determines if there are any additional vehicles within the fleet of vehicles which require additional power to complete the trips planned for the day due to a low state of charge. If there are any such vehicles, the system proceeds to step 314 and supplies the excess power from the vehicle to the other vehicle that needs the additional power. As such, this step allows for vehicle-to-vehicle energy transfer.

On the other hand, if there is no such vehicle in need of additional power, the system then proceeds to step 316 and determines if the current time falls within a period of time when the price of electricity is high, as defined using a graph or table comparing the time of day to the price of electricity during each hour, an example of which is shown in FIG. 2. If the current time falls within this period of time, the system proceeds to step 318 and supplies the excess power from the vehicle to the power grid, which in one example is coupled to an institution such as a school which may then use the electricity provided from the vehicle instead of obtaining electricity from an electricity company to save on an electricity bill. Otherwise, if the current time falls within a period of time when the price of electricity is low, the system proceeds to step 320, where the vehicle is maintained in a standby mode until the next trip begins. FIG. 3 shows an embodiment as disclosed herein, and other examples can omit one or more of the steps as shown, as appropriate, or change the order in which the system proceeds from one step to the next.

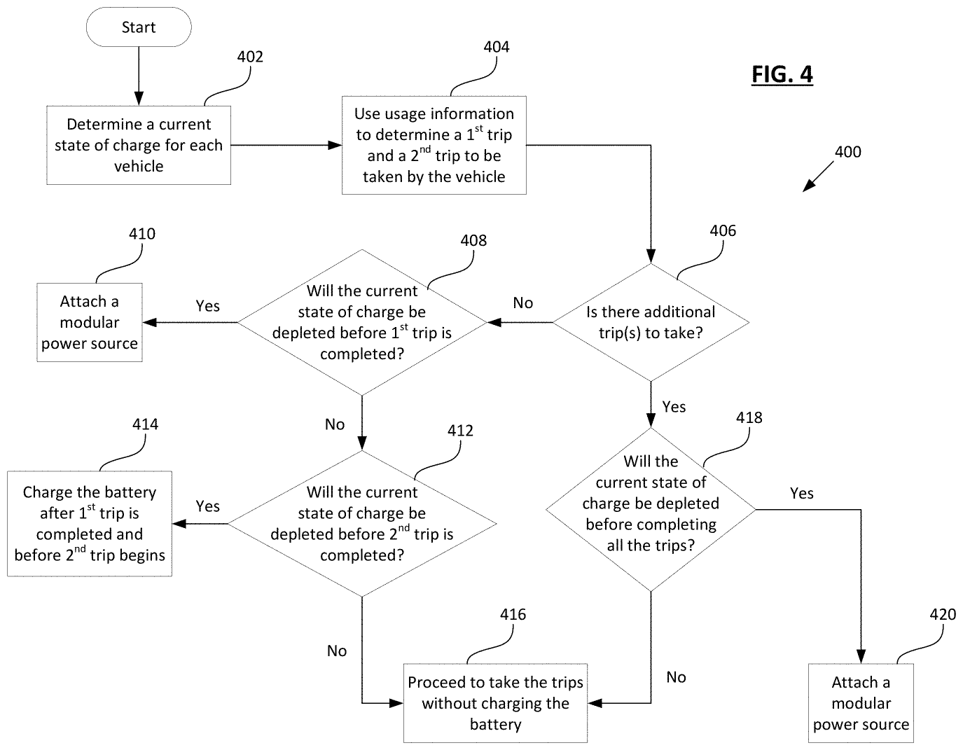

FIG. 4 shows another flow chart representing a method 400 used in the management system of at least one electric vehicle in a fleet of electric vehicles according to one embodiment disclosed herein. In this method, the initial step 402 involves determining a current state of charge. Afterwards, in the following step 404, the usage information of the vehicle is used to determine a first trip and a second trip to be taken by the vehicle, where the first trip is taken first chronologically and the second trip is taken at a period of time following the completion of the first trip. For example, the usage information can include the day's schedule of where the vehicle needs to travel, or the periods of time during which the vehicle will be on the road. Based on the usage information, the system proceeds to step 406 and determines if there is one or more trip that the vehicle needs to take in addition to the first and second trips.

If there is no additional trip, i.e. the only scheduled trips for the day are the first and the second trips, the system then proceeds to step 408 and determines if the current state of charge will be depleted before the first trip is completed. If the system determines that the current state of charge will be depleted, i.e. the vehicle will not be able to complete the first trip based on the current state of charge, the system proceeds to step 410 and a modular power source is attached to the vehicle so that the vehicle can complete the first trip.

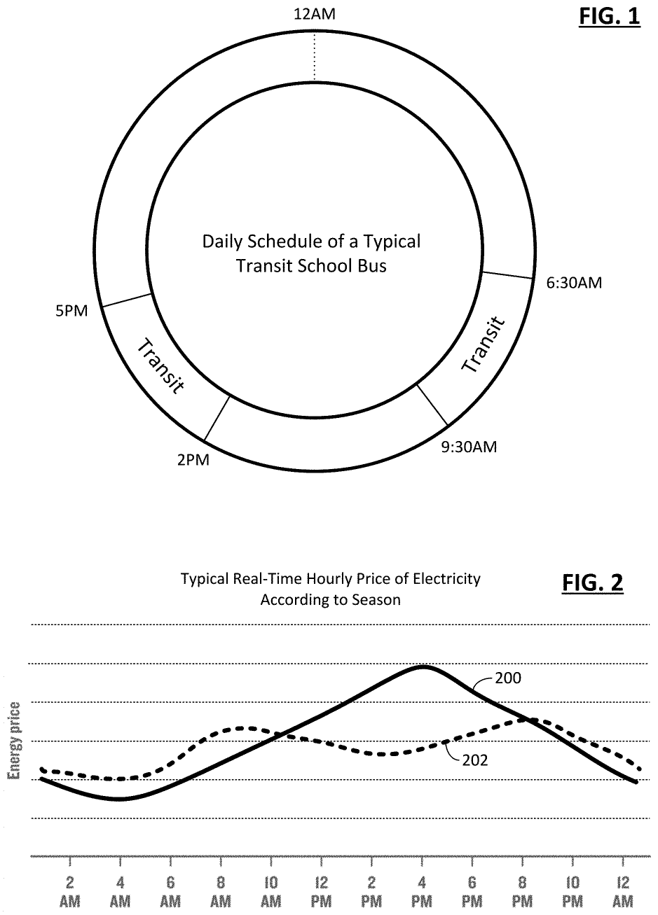

Alternatively, if the system determines that the current state of charge will last the vehicle through the first trip, the system proceeds to step 412 where it determines if the current state of charge will be depleted before the second trip is completed, after the first trip is completed. If it is determined that the state of charge will be depleted, the system proceeds to step 414 where the battery is charged during the period of time after the first trip is completed and before the second trip begins. In one example, as shown in FIG. 1, school buses make the first trip between 6:30 AM and 9:30 AM, and the second trip between 2:00 PM and 5:00 PM. Therefore, in this example, these school buses have 4.5 hours between 9:30 AM and 2:00 PM in which they are not used, leaving the batteries available for charging. The school buses' batteries are charged during this time if the step 414 is performed. Otherwise, the system proceeds to step 416 where the vehicle proceeds to take the assigned trips without charging the battery.

If there is a third, and subsequent, trip (i.e. one or more additional trip) to be taken by the vehicle, as determined in the step 406, the system proceeds to step 418 where the system determines if the current state of charge will be depleted before completing all the assigned trips. If the system determines that the vehicle has a risk of depleting the current state of charge before completing the first, second, and third (as well as any additional subsequent) trips, the system proceeds to step 420 where the modular power source is attached to the vehicle. Otherwise, the system proceeds to the step 416. In one example, the system makes no determination regarding the additional trip as in step 406 because the system knows beforehand that the vehicle always makes only two trips per day. As such, in this example, the step 406 may be omitted and the system proceeds directly from the step 404 to the step 408.

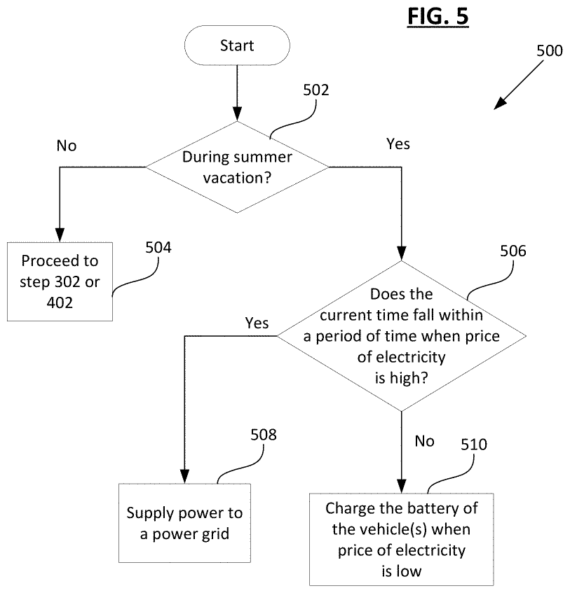

FIG. 5 shows yet another flow chart representing a method 500 used in the management system of at least one electric vehicle in a fleet of electric vehicles according to one embodiment disclosed herein, where the method 500 additionally takes into account the time of the year in which the vehicles operate. In this method, the initial step 502 involves determining if summer vacation has begun and not yet ended for one or more institutions (e.g. school) for whom the driver of the vehicle (e.g. school bus) works.

If the summer vacation has not begun or has ended for the one or more institutions, the system proceeds to step 504, where either the method 300 or 400 is implemented, as appropriate. Otherwise, the system proceeds to step 506 to determine if the current time falls within a period of time when the price of electricity is high. If the current time is when the price of electricity is high, the system proceeds to step 508 to supply power from the battery of the vehicle to the power grid, such as the power grid of the school. Otherwise, the system proceeds to step 510 and the battery of the vehicle is charged when the price of electricity is low.

In one example, the vehicles are a fleet of school buses that are not used because there is no need to drive students to and from school. Therefore, many school buses are parked at the school with no trips planned for the day, except for a few of the buses which may be scheduled to drive students to locations for certain activities. During the summer, as shown in the graph in FIG. 2, the price of electricity is normally especially high in the daytime, increasing from the lowest price at 4:00 AM until its peak price in 4:00 PM. As such, when students may be in school for summer classes or activities during the day, it is advantageous to provide power from the school buses which have no trips planned (and therefore, these school buses have no predicted power demand at all for the day) to the power grid of the school to save on an electricity bill. The batteries of these buses can be recharged at a later time when the price of electricity is low, such as during the night. Therefore, this embodiment has the advantage of charging the batteries when the price of electricity is low, and then powering the power grid when the price of electricity is high. Additionally, the power stored in the batteries can be sold back to the electricity company when demand for electricity is the highest during the day, to reduce the risk of brownouts and blackouts.

In another example of the embodiment, there is an additional step of determining if the vehicle (in this case, school bus) has a predicted power demand based on the usage information, after the step 502. Then, based on the predicted power demand, the controller decides whether the school bus is one of the school buses that drive students to locations for certain activities. If the school bus is used for such activities, the school bus does not provide power to the power grid at all, and the controller checks whether the current state of charge of the school bus satisfies the predicted power demand, similar to step 304. If there is not enough power in the battery of the school bus, the controller sends a notification to the user to attach a modular power source to the school bus.

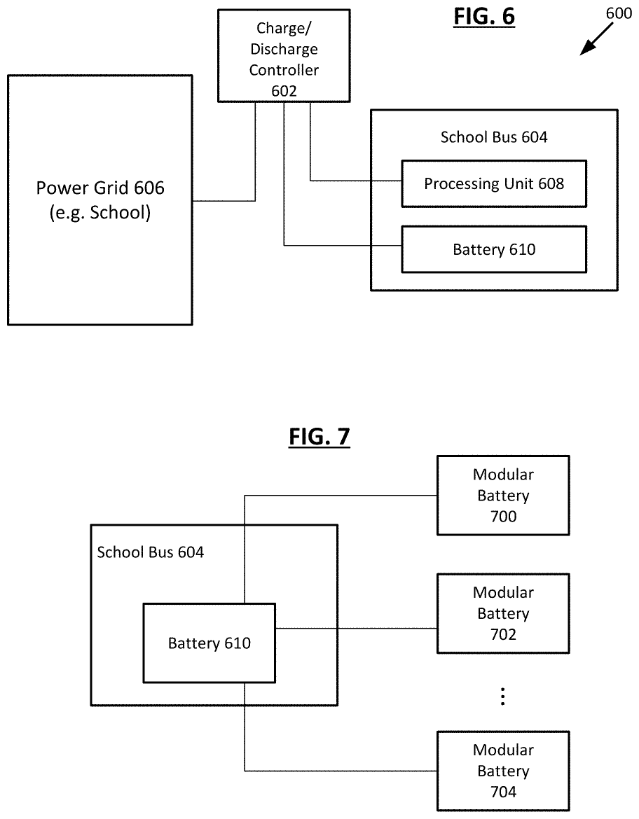

FIG. 6 shows one example of an embodiment of the management system 600 of one of the school buses in the fleet of buses that are managed by the system. The system includes a charge/discharge controller 602 connecting the school bus 604 with the power grid 606, which in one example is located in a school. The school bus 604 has a processing unit 608 and a battery 610. The controller 602 manages the electrical charge flow between the power grid 606 and the battery 610 so that electricity is either provided from the power grid 606 to the battery 610 or from the battery 610 to the power grid 606. The processing unit 608 in one example has memory to store the usage information of the bus 604 which the controller 602 obtains and uses to determine the predicted power demand for the bus, and in another example the processing unit 608 can be inside a mobile device coupled to the school bus 604 which has software applications to track the GPS information of the bus for use by the controller 602. The controller 602 can be a computer system with one or more processing units capable of receiving digital information from the processing unit 608 to make decisions. In one example, the controller 602 also determines whether additional charge is required using the methods described herein, in which the controller sends a notification to alert the user that a modular battery (not depicted) should be attached to the battery 610 to increase the current state of charge. The notification may be displayed on the display of the user's smartphone, or on a computer monitor coupled to the controller, for example.

FIG. 7 shows one example of an embodiment of a school bus 604 whose battery 610 is attached to a plurality of modular batteries 700, 702, and 704. Any number of the modular batteries 700, 702, and 704 can be attached to the battery 610 provided that the total state of charge of the battery after adding on these batteries will be enough to power the school bus 604 until all the trips that are planned for the bus 604 for the day are completed, i.e. the bus 604 does not stop on the road due to the lack of power. Advantages in this embodiment include flexibility with regards to how much additional charge can be added to the battery, so that adding a modular battery that would last two additional trips would not be necessary if the vehicle's battery only requires additional power to last one additional trip, for example. Therefore, a set of smaller modular batteries can be attached instead of one larger modular battery which may provide more power than is needed by the vehicle, and the larger modular battery can be used in a different vehicle which requires all the power that it provides. Also, if the vehicle needs more power than can be provided by a modular battery, attaching additional modular batteries will enable the state of charge to meet the predicted power demand for the vehicle.

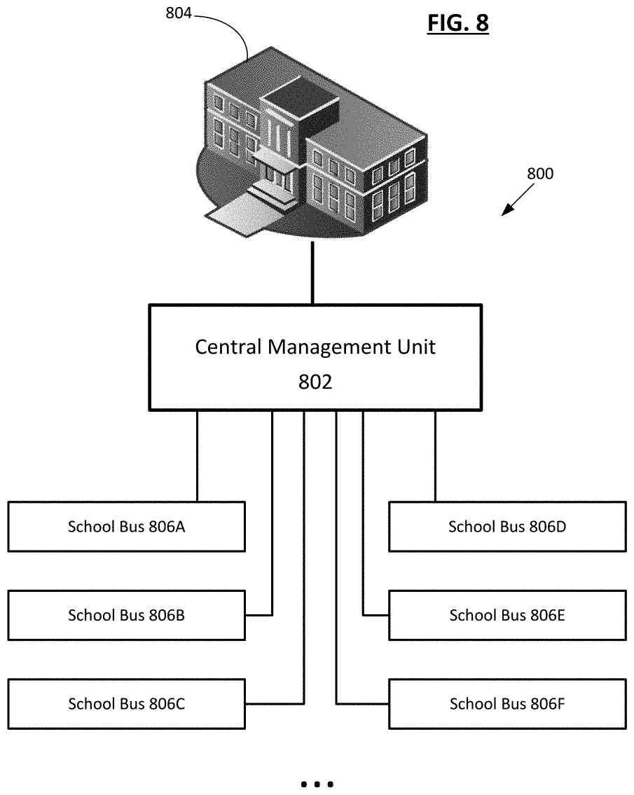

FIG. 8 shows a centralized power management system 800 which uses a central management unit 802 to manage and control the charge flow among an institution 804, which has a power grid, and a fleet of school buses 806 of any number. As such, the central management unit 802 enables electrical charge to flow from the institution 804 to any of the buses 806, from any of the buses 806 to the institution 804, and between any two or more of the buses 806. The central management unit 802 includes processors and memory units which enable the central management unit 802 to make decisions regarding how power is to be transferred among the institution 804 and the buses 806, using the methods as described herein.

The present subject matter may be embodied in other specific forms without departing from the scope of the present disclosure. The described embodiments are to be considered in all respects only as illustrative and not restrictive. Those skilled in the art will recognize that other implementations consistent with the disclosed embodiments are possible. The above detailed description and the examples described therein have been presented for the purposes of illustration and description only and not for limitation. For example, the operations described can be done in any suitable manner. The methods can be performed in any suitable order while still providing the described operation and results. It is therefore contemplated that the present embodiments cover any and all modifications, variations, or equivalents that fall within the scope of the basic underlying principles disclosed above and claimed herein. Furthermore, while the above description describes hardware in the form of a processor executing code, hardware in the form of a state machine, or dedicated logic capable of producing the same effect, other structures are also contemplated.

What is claimed is:

1. A method for managing power for a plurality of electric vehicles, the plurality of electric vehicles each including a battery, the method comprising:
determining a current state of charge of the battery and a predicted power demand for each of the vehicles; and
charging batteries of the plurality of vehicles during a first period of time when the vehicles are not in use.

2. The method of claim 1, wherein the each of the vehicles makes a first trip and a second trip each day as defined by usage information of the vehicle, and the predicted power demand is calculated based on a distance or time traveled by the vehicle during at least one of the first and second trips.

3. The method of claim 1, further comprising:
attaching a modular power source to at least one of the vehicles when the current state of charge is less than the predicted power demand of the at least one of the vehicles.

4. The method of claim 1, further comprising:
determining that at least one of the vehicles needs additional power when the current state of charge is less than the predicted power demand of at least one of the vehicles;
determining that there is excess power in at least one of the other vehicles when the current state of charge is greater than the predicted power demand of the at least one of the other vehicles; and
supplying the excess power to the at least one of the vehicles from the at least one of the other vehicles.

5. The method of claim 1, further comprising:
determining that there is excess power in at least one of the vehicles when the current state of charge is greater than the predicted power demand of the at least one of the vehicles; and
supplying the excess power to a power grid during a second period of time when a price of electricity is higher than during the first period of time.

6. The method of claim 1, further comprising:
supplying, during a second period of time, power charged during the first period of time to a power grid, wherein a price of electricity is higher during the second period of time than during the first period of time.

7. The method of claim 1, further comprising:
determining which battery of one or more of the vehicles to charge based on the current state of charge and the predicted power demand for the each of the vehicles,
wherein the battery of the one or more of the vehicles is charged when the current state of charge is less than the predicted power demand of the one or more of the vehicles.

8. The method of claim 1, wherein
the each of the vehicles makes a first trip and a second trip each day as defined by usage information of the vehicle,
a first predicted power demand is calculated based on a first distance or time traveled by the vehicle during the first trip, and
a second predicted power demand is calculated based on a second distance or time traveled by the vehicle during the second trip,
the method further comprising:
responding to the current state of charge being greater than the first predicted power demand and less than a sum of the first and second predicted power demands by charging the battery of the vehicle during a second period of time after the first trip is completed and before the second trip begins.

9. An electric vehicle comprising:
a battery configured to be charged during a first period of time when the vehicle is not in use;
sensors configured to detect a current state of charge of the battery and a predicted power demand of the vehicle; and
a controller coupled to the sensors and the battery, wherein the controller is configured to determine that there is excess power in the battery of the vehicle when the current state of charge is greater than the predicted power demand, and supply the excess power to a power grid during a second period of time when a price of electricity is higher than during the first period of time.

10. The electric vehicle of claim 9, wherein the controller is configured to supply, during a second period of time, power charged during the first period of time to a power grid, wherein a price of electricity is higher during the second period of time than during the first period of time.

11. The electric vehicle of claim 9, wherein the vehicle further comprises:
a memory unit configured to store usage information of the vehicle,
wherein a first predicted power demand is calculated based on a first distance or time traveled by the vehicle during a first trip as defined by the usage information, and a second predicted power demand is calculated based on a second distance or time traveled by the vehicle during a second trip as determined by the usage information,
wherein, if the current state of charge is greater than the first predicted power demand and less than a sum of the first and second predicted power demands, the controller is configured to charge the battery of the vehicle during a second period of time after the first trip is completed and before the second trip begins.

12. The electric vehicle of claim 11, wherein the controller sends a notification to a user to attach a modular power source to the vehicle when the controller determines that the current state of charge would be depleted before at least one of the first and second trips is completed.

13. A system for power management, comprising:
a plurality of electric vehicles, wherein each of the vehicles comprises a battery;
a power grid; and
a central management unit coupled to the vehicles and the power grid, wherein the central management unit is configured to determine a current state of charge and a predicted power demand for each of the vehicles and charge the batteries during a first period of time when the vehicles are not in use.

14. The system of claim 13, wherein each of the vehicles further comprises a memory unit configured to store usage information which defines a first trip and a second trip traveled each day by the vehicle, and the central management unit is configured to calculate the predicted power demand based on a distance or time traveled by the vehicle during at least one of the first and second trips.

15. The system of claim 14, wherein the central management unit is configured to send a notification to attach a modular power source to at least one of the vehicles when the central management unit determines that the current state of charge would be depleted before at least one of the first and second trips is completed.

16. The system of claim 13, wherein the central management unit is configured to
determine that there is excess power in at least one of the vehicles when the current state of charge is greater than the predicted power demand of the at least one of the vehicles; and
supply the excess power to at least one of: a power grid during a second period of time when a price of electricity is higher than during the first period of time and at least one of the other vehicles.

17. The system of claim 13, wherein the central management unit is configured to
supply, during a second period of time, power charged during the first period of time to a power grid, wherein a price of electricity is higher during the second period of time than during the first period of time.

18. The system of claim 13, wherein the central management unit is configured to
determine which battery of one or more of the vehicles to charge based on the current state of charge and the predicted power demand for the each of the vehicles,
wherein the battery of the one or more of the vehicles is charged when the current state of charge is less than the predicted power demand of the one or more of the vehicles.

19. The system of claim 13, wherein
each of the vehicles further comprises a memory unit configured to store usage information of the vehicle which defines a first trip and a second trip traveled each day by the vehicle,
the central management unit is configured to calculate a first predicted power demand based on a first distance or time traveled by the vehicle during the first trip,
the central management unit is configured to calculate a second predicted power demand based on a second distance or time traveled by the vehicle during the second trip, and
if the current state of charge is greater than the first predicted power demand and less than a sum of the first and second predicted power demands, the central management unit is configured to charge the battery of the vehicle during a second period of time after the first trip is completed and before the second trip begins.

20. The electric vehicle of claim 11, wherein the usage information defines at least one additional trip, and the controller sends a notification to a user to attach a modular power source to the vehicle when the controller determines that the current state of charge would be depleted before the at least one additional trip is completed.

21. The system of claim 14, wherein the usage information defines at least one additional trip, and the central management unit is configured to send a notification to attach a modular power source to at least one of the vehicles when the central management unit determines that the current state of charge would be depleted before the at least one additional trip is completed.
